(19) United States
(12) Patent Application Publication
(10) Pub. No.: US 2008/0177542 A1
(43) Pub. Date: Jul. 24, 2008

(54) Voice Recognition Program

(75) Inventor: Hideo Yamamoto, Gifu (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: GIFU SERVICE CORPORATION, Ogaki-shi, Gifu (JP)

(21) Appl. No.: 11/908,334

(22) PCT Filed: Mar. 11, 2005
(86) PCT No.: PCT/JP2005/004303

§ 371 Date: Sep. 11, 2007

(51) Int. Cl. G10L 15/00

(52) U.S. Cl. 704/253; 704/E15.001

(57) ABSTRACT

A voice recognition program according to claim 1 makes a computer execute a start determining word recognizing step for checking whether a start determining word for a sentence recognition is inputted by voice or not, an end determining word recognizing step for checking whether an end determining word for the sentence recognition is inputted by voice or not after the voice input of the start determining word, and a sentence recognizing step for recognizing by voice an intermediate sentence between the start determining word and the end determining word when it is judged that the start determining word and the end determining word are inputted in the start determining word recognizing step and the end determining word recognizing step. Thereby, it simplifies an input work of a fixed sentence, that is applicable to a preparation of a medical record or the like, that improves usability for a user such as a doctor who is unused to a PC operation and that is able to reduce largely a labor and a time for inputting work of the doctor or the like.

### TECHNICAL FIELD

The present invention relates to a voice recognition program that is suitable for an automatic construction of a medical record or the like.

### BACKGROUND ART

Conventionally, for a description of a medical record in a medical institution, a doctor in attendance writes it in its own form by handwriting or inputs it in an input display for exclusive use by a keyboard by him or herself. It is though that, if a voice recognition technique is usable in preparing such medical record or the like, it could also effectively prevent an input error by the handwriting or the keyboard inputting and could also reduce largely a labor and time for inputting work of the handwriting or the keyboard inputting by the doctor or the like. As a technique using the voice recognition technique for the medical record, there is a technique described in a Patent Publication No. 1, for example.

[PATENT PUBLICATION NO. 1] Laid Open Patent Publication 2003-122849

In the Patent Publication No. 1, an electronic medical record system is disclosed in which it performs an input and management of a medical record, while electronically recording a medical information generated in a clinic or other medical institutions. The electronic medical record system has a display monitor of a doctor's terminal for inputting the medical record. The display is composed of a patient information displaying part for a full name, a sex, a birthday and so on relating to the patient, a medical record displaying part for showing a medical record information relating to the patient, an instruction fee and practice information displaying part for showing an instruction fee and practice information relating to the same patient, and, in addition, a shortcut displaying part as a means for searching an intervention information of the same patient depending on a fixed condition. A doctor uses such shortcut function to make displayed a medical record information having contents in accordance with a matched condition on the monitor. The electronic medical record system correlates the shortcut to a keyword. e.g. made of two characters, so as to make the keyword content work in conjunction with a voice recognition means. Thus, it is recited that a simplified input can be realized.

### DISCLOSURE OF THE INVENTION

### Problems to be Solved by the Invention

However, the technique recited in the Patent Publication No. 1 utilizes the voice recognition means only for starting a realization of the shortcut function. Other data inputs still need to be done essentially by use of an input device such as a keyboard or a mouse or the like of a PC. Consequently, it is not sufficient in terms of a laborsaving in a medical record preparing work of a doctor or the like. Moreover, it is possible that the input work becomes difficult for a doctor who is unfamiliar with a PC operation.

Then, it is an object of the present invention to provide a voice recognition program that simplifies an input work of a fixed sentence, that is applicable to a preparation of a medical record or the like, that improves usability for a user such as a doctor who is unused to a PC operation and that is able to reduce largely a labor and a time for inputting work of the doctor or the like.

### Means to Solve the Problems

A voice recognition program according to claim 1 makes a computer execute a start determining word recognizing step for checking whether a start determining word for a sentence recognition is inputted by voice or not, an end determining word recognizing step for checking whether an end determining word for the sentence recognition is inputted by voice or not after the voice input of the start determining word, and a sentence recognizing step for recognizing by voice an intermediate sentence between the start determining word and the end determining word when it is judged that the start determining word and the end determining word are inputted in the start determining word recognizing step and the end determining word recognizing step.

A voice recognition program according to claim 2 is a voice recognition program for recognizing by voice a confirmation sentence which is shown by one dialogist to another dialogist for confirming an information having a predetermined content. It makes a computer execute a word recognizing step for recognizing by voice a sequence of dialogue between the one dialogist and the other dialogist by a phoneme recognition and a word recognition utilizing a phonemic model and a word model so as to monitor words during the dialogue, a start determining word recognizing step for pattern-matching the monitored words in the word recognizing step to a predetermined start determining word, which consists of a connective added just before the confirmation sentence to constitute a line of sentence, so as to check whether the start determining word is inputted by voice or not, an end determining word recognizing step for pattern-matching the monitored words in the word recognizing step to a predetermined end determining word, which consists of an auxiliary verb added just after the confirmation sentence to constitute the line of sentence, so as to check whether the end determining word is inputted by voice or not, and a sentence recognizing step for recognizing by voice an intermediate sentence between the start determining word and the end determining word only when the end determining word is inputted by voice after the start determining word is inputted by voice.

A voice recognition program according to claim 3 makes the computer further execute, in the configuration of claim 1 or 2, a sentence converting step for pattern-matching the intermediate sentence consisting of a colloquial sentence recognized by voice in the sentence recognizing step to fixed sentences consisting of literary sentences stored preliminarily in a storage means so as to output a fixed sentence corresponding to the intermediate sentence.

### Effects of the Invention

The voice recognition program according to the present invention simplifies an input work of a fixed sentence, is applicable to a preparation of a medical record or the like, improves usability for a user such as a doctor who is unused to a PC operation and is able to reduce largely a labor and a time for inputting work of the doctor or the like.

### BRIEF DESCRIPTION OF THE DRAWINGS

FIG. 1 is a function block diagram showing main function realizing means of a computer that executes a voice recognition program according to one embodiment of the invention.

FIG. 2 is a flowchart showing a procedure of the voice recognition program according to the one embodiment of the invention.

### Description of Codes

STEP 7: start determining word recognizing step

STEP 8: end determining word recognizing step

STEP 9: intermediate sentence recognizing step

### BEST MODE FOR EMBODYING THE INVENTION

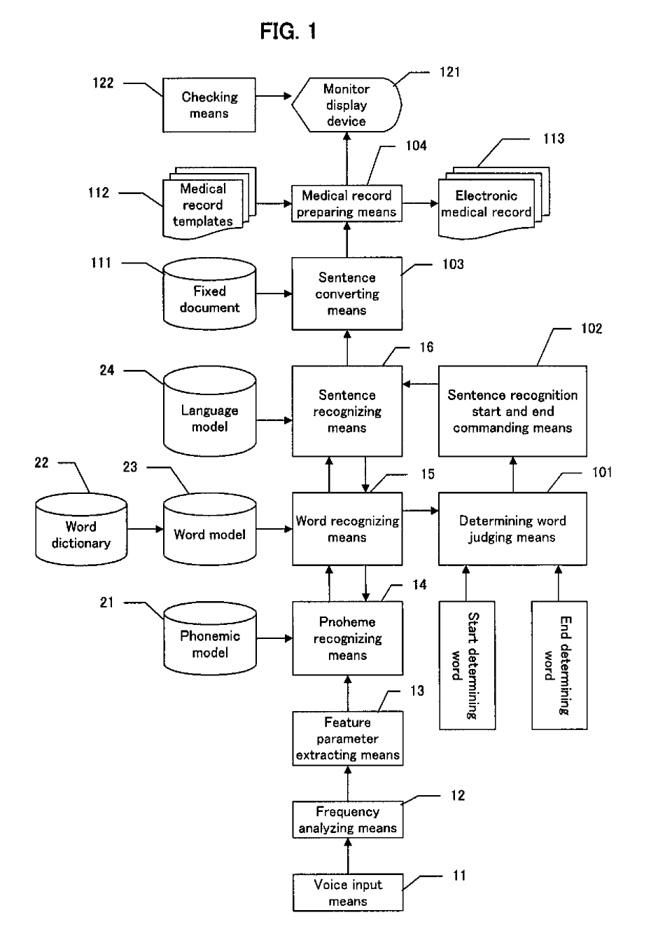

A best mode (referred to as “embodiment” hereafter) for practicing the present invention is described below. FIG. 1 is a function block diagram showing main function realizing means of a computer that executes a voice recognition program according to one embodiment of the invention.

The voice recognition program of the present embodiment is concretized into a voice recognition program for recognizing by voice a confirmation sentence (a fixed sentence) which is shown by one dialogist to another dialogist for confirming an information having a predetermined content. For example, the present embodiment of the voice recognition program can be concretized into a voice recognition program for recognizing by voice a confirmation sentence (a sentence to be filled into a medical record as a fixed sentence) which is shown by a doctor as one dialogist to an outpatient or an inpatient as another dialogist for confirming a content of a matter that needs to be filled in the medical record. The present embodiment of the voice recognition program makes a voice recognition device, which is composed of a computer (PC, PDA, office computer or the like) having a general configuration such as CPU, ROM, RAM and so on, execute a sequence of procedure, as shown in FIG. 1. The voice recognition device shown in FIG. 1 converts a voice into an electric signal by a voice input means 11 composed of a close-talking microphone, a nondirectional microphone or the like. Moreover, the voice recognition device separates a voice signal (speech waveform), which is inputted from the voice input means 11, into every frame of several microseconds to several tens of microseconds, for example, by a frequency analyzing means 12 and a feature parameter extracting means 13. Then, it calculates a spectrum for each of the frames by a fast Fourier transformation and converts the spectrum into a vocal parameter on the basis of an auditory measure, while removing a noise. Furthermore, the voice recognition device matches the inputted voice to a phonemic model in a phonemic model storage means 21, which represents a time series of the vocal parameter, by a phoneme recognizing means 14. The phonemic model is learned from many data by use of a hidden Markov model (HMM) or the like.

In addition, the voice recognition device matches a phonemic recognition result to a word model in a word model storage means 23, which is converted from a word dictionary 22, by a word recognizing means 15 so as to calculate a coincidence of the both. That is, the word recognizing means 15 compares the preliminarily stored word model with inputted voice data so as to calculate to which stored word the inputted voice data is the most similar. Then, it outputs the most similar one as a recognition result (pattern-matching). As the word model, there is prepared a model taking into account a deformation of a phoneme such as devocalization, lengthening and nasalization of a vowel or palatalization of a consonant in the word. Moreover, a variation of a vocalizing timing of each phoneme is dealt with by a matching method using a principle of a dynamic programming (DP matching). The word recognizing means 15 uses the word dictionary 22 that stores a limited number of words (words included in a fixed sentence described later). It selects a word having a highest coincidence in the word dictionary 22 even if the phonemic recognition result by the phoneme recognizing means 14 is erroneous. Thus, it improves a recognition rate as the word. As described above, the voice recognition program uses the frequency analyzing means 12, the feature parameter extracting means 13, the phoneme recognizing means 14 and the word recognizing means 15. Then it executes a word recognizing step in which it recognizes by voice a sequence of dialogue between the one dialogist and the other dialogist by the phonemic recognition and the word recognition utilizing the phonemic model and the word model, thereby monitoring words in the dialogue.

The voice recognition device picks out a series of words matching a language model in a language model storage means 24 from the word recognition result by a sentence recognition means 16. Moreover, the sentence recognition means 16 gives a limitation that a series of the inputted words is vocalized in accordance with a predetermined language model, thereby improving a recognition rate as a sentence by such grammar. On the other hand, the voice recognition device inputs the words recognized by the word recognizing means 15 into a determining word judging means 101. The determining word judging means 101 stores one pair or many pairs of start determining words and end determining words as keywords making up a predetermined pair. It pattern-matches a word inputted from the word recognizing means 15 to the start determining word and the end determining word prepared in advance. Then, it judges and confirms whether the start determining word and the end determining word are inputted by voice or not. That is, the determining word judging means 101 executes a start determining word recognizing step for pattern-matching the words monitored by the word recognizing means 15 to a predetermined start determining word, which consists of a connective added just before a confirmation sentence to constitute a line of sentence, so as to check whether the start determining word is inputted by voice or not. Moreover, it executes an end determining word recognizing step for pattern-matching the words monitored in the word recognizing step to a predetermined end determining word, which consists of an auxiliary verb added just after the confirmation sentence to constitute the line of sentence, so as to check whether the end determining word is inputted by voice or not.

When the determining word judging means 101 confirms a voice input of the start determining word, it outputs the result to a sentence recognition start and end commanding means 102. On the basis of it, the sentence recognition start and end commanding means 102 commands the sentence recognizing means 16 to start a sentence recognition by a language model. Moreover, when the determining word judging means 101 confirms a voice input of the end determining word, it outputs the result to the sentence recognition start and end commanding means 102. On the basis of it, the sentence recognition start and end commanding means 102 commands the sentence recognizing means 16 to end the sentence recognition by the language model. Then, the sentence recognizing means 16 realizes its function only when there is a command from the sentence recognition start and end commanding means 102. The sentence recognizing means 16 executes a sentence recognizing step for recognizing by voice an intermediate sentence between the start determining word and the end determining word only when the end determining word is inputted by voice after the start determining word is inputted by voice. At this time, it is preferably structured such that the sentence recognizing means or the commanding means does not command if the end determining word is spoken in succession just after the start determining word, that is, if there is no intermediate sentence, but such that it executes the command only when the end determining word is inputted after a predetermined time has passed since the input of the start determining word. Moreover, it is preferably structured such that it executes the command only when some words other than the end determining word are inputted just after the start determining word and then the end determining word is inputted. The sentence recognizing means 16 recognizes by voice the intermediate sentence by a common voice recognition composed of a phoneme recognition, a word recognition and a sentence recognition utilizing a phonemic model, a word model and a language model.

The start determining word may be a connective (copulative conjunction, explanatory one, switching one or the like) such as “Then”. In addition to “Then”, “Well”, “Now”, “OK”, “Therefore”, “So”, “And”, “Thus”, “Accordingly”, “As a result”, “In the end”, “In fact”, “That is”, “Hence”, “Thereby”, “Consequently”, “In essence”, “In short”, “In conclusion” and so on are usable, too. The end determining word may be an end word of a tag question (a word seeking consensus of another party) or an auxiliary verb or the like such as “isn't it”. In addition to “isn't it”, “aren't they”, “aren't you”, “doesn't it”, “don't they”, “don't you”, “hasn't it”, “is”, “are”, “do” and so on are usable, too. As one example of the intermediate sentence, there are sentences for expressing vital data or disease state or the like as matters to be written in the medical record. For example, there are sentences such as “your fever is 38 degrees”, “your blood pressure is 130 at the highest and 95 at the lowest”, “you have a headache since last night”, “you have little appetite since yesterday”, “you have a touch of diarrhea since two days before” or the like. Therefore, the confirmation sentence consisting of the start determining word, the end determining word and the intermediate sentence may be “Then, your fever is 38 degrees, isn't it?”, “Then, your blood pressure is 130 at the highest and 95 at the lowest, isn't it?”, “Then, you have a headache since last night, aren't you?”, “Then, you have little appetite since yesterday, aren't you?”, “Then, you have a touch of diarrhea since two days before, aren't you?” or the like. In these cases, the sentence recognizing means 16 recognizes by voice only the intermediate sentence in the confirmation sentence, that is, “the fever is 38 degrees”, “the blood pressure is 130 at the highest and 95 at the lowest”, “you have a headache since last night”, “you have little appetite since yesterday” or “you have a touch of diarrhea since two days before”, thereby outputting it to a sentence converting means 103.

The voice recognition device executes a sentence converting step for pattern-matching the intermediate sentence consisting of a colloquial sentence recognized by voice by the sentence recognizing means 16 to fixed sentences consisting of literary sentences stored preliminarily in a fixed sentence dictionary 111 so as to output a fixed sentence corresponding to the intermediate sentence. The fixed sentences stored in the fixed sentence dictionary 111 are literary sentences corresponding to the intermediate sentences such as “the fever is 38 degrees”, “the blood pressure is 130 at the highest and 95 at the lowest”, “he (she) has a headache since last night”, “he (she) has little appetite since yesterday”, “he (she) has a touch of diarrhea since two days before” or the like. Moreover, the voice recognition device outputs the fixed sentence obtained by the pattern-matching of the sentence converting means 103 to a medical record preparing means 104. The medical record preparing means 104 executes a procedure for retrieving a medical record template 112 to prepare a medical record 113 (not filled yet) and then filling in series the fixed sentences inputted from the sentence converting means 103 into a predetermined form of the electronic medical record 113. Furthermore, the voice recognition device outputs the fixed sentences from the sentence converting means 103 on a monitor display device 121 made by a monitor or the like of PC by use of the medical record preparing means 104, thereby displaying the fixed sentences on the monitor display device 121. In addition, the voice recognition device connects a checking means 122 to the monitor display device 121 so as to enable a user such as a doctor to confirm the fixed sentences displayed on the monitor display device 121 and carry out an editing operation by the checking means 121 such as adding, eliminating, correcting or the like of the inputted fixed sentences.

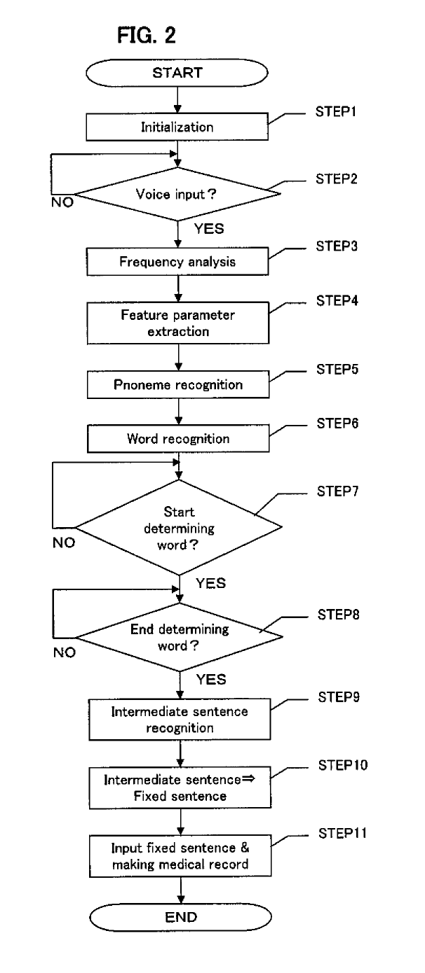

Next, operating procedures of the voice recognition program according to the present embodiment is described. FIG. 2 is a flowchart showing a procedure of the voice recognition program according to the one embodiment of the invention.

As shown in FIG. 2, in the voice recognition program according to the present embodiment, a boot process is executed first. Then, an initializing process is executed in STEP 1, so that the medical record preparing means 104 references the medical record templates 112 and prepares an electronic medical record 113 of a required format. Next, when a voice input is made from the voice input means 11 in STEP 2, the frequency analyzing means 12 executes a frequency analyzing process in STEP 3 and the feature parameter extracting means 13 executes an extracting process of a voice parameter in STEP 4. Next, in STEP 5, the phoneme recognizing means 14 references the phonemic model 21 to execute a phonemic recognizing process on the basis of the voice parameter. Then, in STEP 6, the word recognizing means 15 references the word model 23 to execute a word recognizing process on the basis of the phonemic recognition result. Next, in STEP 7, the determining word judging means 101 judges whether the start determining word is inputted or not on the basis of the inputted words from the word recognizing means 15. STEP 7 constitutes a start determining word recognizing step for judging whether the start determining word is inputted by voice or not for the sentence recognition. Next, if STEP 7 is YES, the determining word judging means 101 judges in STEP 8 whether the end determining word is inputted or not on the basis of the inputted words from the word recognizing means 15. STEP 8 constitutes an end determining word recognizing step for judging whether the end determining word is inputted by voice or not for the sentence recognition after the input of the voice of the start determining word. If the input of the start determining word is confirmed in STEP 7 and the input of the end determining word is confirmed in STEP 8, in STEP 9, the sentence recognition start and end commanding means 102 commands the sentence recognizing means 16 to recognize the sentence on the basis of the input from the determining word judging means 101. On the basis of the command, the sentence recognizing means 16 executes a recognizing process of the intermediate sentence. At this time, the sentence recognizing means 16 utilizes the recognition result of the phoneme recognizing step (STEP 5) and the word recognizing step (STEP 6) to recognize by voice the intermediate sentence, while referencing the language model. STEP 9 constitutes a sentence recognizing step for recognizing by voice the intermediate sentence between the start determining word and the end determining word (just after the start determining word to just before the end determining word) when it is judged that the start determining word and the end determining word are inputted in the start determining word recognizing step and the end determining word recognizing step. Next, in STEP 10, the sentence converting means 103 compares the intermediate sentence inputted from the sentence recognizing means 16 with the fixed sentence of the fixed sentence dictionary 111 to execute a pattern-matching process, thereby converting the intermediate sentence to a corresponding sentence (literary sentence). Next, in STEP 11, the medical record preparing means 104 fills the fixed sentence inputted from the sentence converting means 103 into a predetermined form of the prepared electronic medical record 113, thereby making the electronic medical record (filled out). After STEP 11, the fixed sentences from the medical record preparing means 104 are displayed on the monitor display device 121 so as to enable the doctor to check the filled contents by use of the checking means 122.

As described above, the voice recognition program repeats the aforementioned STEP 2 to STEP 11 so as to monitor a dialogue between a doctor and a patient by STEP 2 to STEP 6. Then, the voice recognition program makes only the fixed sentences corresponding to the intermediate sentences in the plurality of the confirmation sentences (start determining word plus intermediate sentence plus end determining word), which are spoken by the doctor during the dialogue, filled out in series in the electronic medical record 113 by STEP 7 to STEP 11. Thus, the voice recognition program is able to complete the preparation of the electronic medical record 113.

In the above-mentioned procedures, the intermediate sentence recognition is executed in STEP 9 after the start determining word is checked in STEP 7 and the end determining word is checked in STEP 8. However, it may be configured such that it executes the intermediate sentence recognition of STEP 9 just after confirming the start determining word in STEP 7 and terminates the intermediate sentence recognition of STEP 9 after confirming the end determining word in the next step. Moreover, it may be configured such that it selects a plurality of fixed sentences as candidates corresponding to the intermediate sentence at the time of selecting the fixed sentence in STEP 10 and displays them as a list in the monitor display device 121. In this case, it may be structured such that the doctor confirms the plurality of the fixed sentences displayed on the monitor display device 121 and selects the most suitable fixed sentence to fill it in the electronic medical record 113.

As described above, the voice recognition program according to the present invention simplifies the input work of the fixed sentence as the matters to be filled in the medical record in a diagnostic process with an interview made by the doctor to the outpatient or the inpatient. Moreover, it can improve usability for the doctor who is unfamiliar with the PC operation, thereby reducing largely the labor and the time for inputting work of the doctor. Furthermore, according to the present invention, the voice recognition during the dialogue is just performed until the step of the word recognition as the step before the sentence recognition. The sentence recognition (recognition of the fixed sentence as the intermediate sentence) is started only after the input of the start determining word the end determining word is confirmed. Therefore, it is possible to largely reduce a throughput of the voice recognition. Particularly, it is enough to prepare the start determining word and the end determining word for the command for starting and ending the intermediate sentence recognition. Accordingly, in case the start determining word and the end determining word are set as “Then” and “isn't it”, for example, the word recognizing means 15 has only to recognize the words having a first phoneme of “T” or “I”. Thus, it is possible to lessen the throughput of the phoneme recognizing means 14 to a large extent. Moreover, the word dictionary 22 and the word model have only to be configured corresponding to the words within a coverage of the fixed sentences, thereby cutting down the throughput. Furthermore, the language model has only to be configured corresponding to the words within a range included in the fixed sentences that need to be prepared beforehand. Thus, the throughput can be lowered to a large degree, too. In addition, the registered words can be lessened, so that an incidence rate of false recognition can be reduced, thereby improving the recognition rate considerably. In addition, with respect to a common continuous speech recognition, a human is not a machine and does not speak continuously and smoothly. Then, there are a variety of speech phenomenons such as he or she miswords or gets thoughtful between a word and a word (hesitation in speech) or unconsciously puts “of” or the like. In contrast, the present invention prepares a set of the start determining word, the intermediate sentence and the end determining word that are spoken as a line of sentence as described above (“Then, - - - , isn't it?). Consequently, the invention can recognizes the sentence or the confirmation sentence in the continuous sentences, thereby preventing an influence by the speech phenomenon such as the above-mentioned hesitation of speech or the like.

In the present invention, a waveform signal (analog signal) of a dialogue voice is continuously inputted from the voice input means 11 such as a microphone during a series of dialogue between a speaker (authorized person) such as a doctor and a receiver (patient or the like). At this time, it is desirable to configure it such that a sound pattern of the speaker is inputted and specified in advance so as to execute the above-mentioned processes only when it is judged that the start determining word, the intermediate sentence and the end determining word are ones of the speaker, while neglecting a speech of a non-authorized person. With such configuration, it is possible to prevent a speech of other person than the authorized person from being erroneously inputted.

### INDUSTRIAL APPLICABILITY

The voice recognition program according to the present invention is applicable to a variety of uses in case of automatically inputting a fixed sentence into a document or the like, in such a purpose as an automatic preparation of a medical record.

1. A voice recognition program characterized by making a computer execute:
a start determining word recognizing step for checking whether a start determining word for a sentence recognition is inputted by voice or not;
an end determining word recognizing step for checking whether an end determining word for the sentence recognition is inputted by voice or not after the voice input of the start determining word; and
a sentence recognizing step for recognizing by voice an intermediate sentence between the start determining word and the end determining word when it is judged that the start determining word and the end determining word are inputted in the start determining word recognizing step and the end determining word recognizing step;
wherein a set of a start determining word, an end determining word and an intermediate sentence that are spoken as a line of sentence as the start determining word, the end determining word and the intermediate sentence, while storing a plurality of fixed sentences as the intermediate sentence in a fixed sentence dictionary, so as to execute a sentence converting step for pattern-matching the intermediate sentence recognized by voice in the sentence recognizing step to each of the fixed sentences stored in the fixed sentence dictionary thereby outputting a fixed sentence corresponding to the intermediate sentence.

2. A voice recognition program for recognizing by voice a confirmation sentence which is shown by one dialogist to another dialogist for confirming an information having a predetermined content, characterized by making a computer execute:
a word recognizing step for recognizing by voice a sequence of dialogue between the one dialogist and the other dialogist by a phoneme recognition and a word recognition utilizing a phonemic model and a word model so as to monitor words during the dialogue;
a start determining word recognizing step for pattern-matching the monitored words in the word recognizing step to a predetermined start determining word, which consists of a connective added just before the confirmation sentence to constitute a line of sentence, so as to check whether the start determining word is inputted by voice or not;
an end determining word recognizing step for pattern-matching the monitored words in the word recognizing step to a predetermined end determining word, which consists of an auxiliary verb added just after the confirmation sentence to constitute the line of sentence, so as to check whether the end determining word is inputted by voice or not; and
a sentence recognizing step for recognizing by voice an intermediate sentence between the start determining word and the end determining word only when the end determining word is inputted by voice after the start determining word is inputted by voice;
wherein a set of a start determining word, an end determining word and an intermediate sentence that are spoken as a line of sentence as the start determining word, the end determining word and the intermediate sentence, while storing a plurality of fixed sentences as the intermediate sentence in a fixed sentence dictionary, so as to execute a sentence converting step for pattern-matching the intermediate sentence recognized by voice in the sentence recognizing step to each of the fixed sentences stored in the fixed sentence dictionary thereby outputting a fixed sentence corresponding to the intermediate sentence.

3. A voice recognition program as recited in claim 1 or 2, characterized in that the sentence converting step pattern-matches the intermediate sentence consisting of a colloquial sentence recognized by voice in the sentence recognizing step to fixed sentences consisting of literary sentences stored preliminarily in a storage means so as to output a fixed sentence corresponding to the intermediate sentence.

4. A voice recognition program as recited in claim 1 or 2, characterized in that the sentence converting step is not executed in case the intermediate sentence does not exist between the start determining word and the end determining word but is executed only when a word other than the end determining word is inputted just after the start determining word and the end determining word is inputted thereafter

5. A voice recognition program as recited in claim 2, characterized by:
using a limited number of connectives such as a copulative conjunction, explanatory one and switching one stored in a word dictionary as the start determining word;
using a limited number of end words of a tag question or auxiliary verbs stored in the word dictionary as the end determining word;
using as the intermediate sentence a sentence that is stored in the fixed sentence dictionary as the fixed sentence and that is filled in a medical record which a doctor as the one dialogist shows to a patient as the other dialogist for confirmation;
combining the start determining word, the intermediate sentence and the end determining word to make up the set so as to make it correspond to a colloquial sentence corresponding to a sentence filled in the medical record that is spoken by the doctor during a talk with the patient; and
making the computer execute a step for monitoring a dialogue between the doctor and the patient and filling in series only the fixed sentence corresponding to the intermediate sentence recognized in the sentence recognizing step into an electronic medical record from a plurality of sentences spoken by the doctor during the dialogue.

6. A voice recognition program as recited in claim 5, characterized by making the computer execute:
a step for showing as a list a plurality of fixed sentences as candidates if the plurality of the fixed sentences as the candidates exist corresponding to the intermediate sentence when the intermediate sentence recognized by voice is pattern-matched to each of the fixed sentences stored in the fixed sentence dictionary in the sentence recognizing step; and
a step for making the doctor confirm the plurality of the fixed sentences as the candidates shown as the list and select a most suitable fixed sentence, thereby filling the selected most suitable fixed sentence into the electronic medical record.

7. A voice recognition program as recited in claim 3, characterized in that the sentence converting step is not executed in case the intermediate sentence does not exist between the start determining word and the end determining word but is executed only when a word other than the end determining word is inputted just after the start determining word and the end determining word is inputted thereafter.
